(19) United States
(12) Patent Application Publication
(10) Pub. No.: US 2010/0128344 A1
(43) Pub. Date: May 27, 2010

(54) TECHNIQUE FOR COMPENSATING UNDESIRED EFFECTS IN OPTICAL LINKS OF AN OPTICAL COMMUNICATION NETWORK

(75) Inventor: Eyal Lichtman, Ramat Gan (IL)

Correspondence Address: BROWDY AND NEIMARK, P.L.L.C.;624 NINTH STREET, NW, SUITE 300, WASHINGTON, DC, 20001-5303, US

(73) Assignee: ECI TELECOM LTD., Petach Tikva (IL)

(21) Appl. No.: 12/596,728

(22) PCT Filed: Apr. 7, 2008
(86) PCT No.: PCT/IL08/00478

§ 371 Date: Oct. 20, 2009

(30) Foreign Application Priority Data
May 2, 2007 (IL) 182937

(51) Int. Cl. H04B 10/18; H04B 10/17

(52) U.S. Cl. 359/337.4

(57) ABSTRACT

A technique for compensating undesired effects in optical links of an optical communication network, using adjustment modules suitable for inserting into optical links, preferably into the links incoming network nodes. Each of the adjustment modules serves for compensating two or more different physical effects accumulated in the optical link when transmitting an optical signal there-along. The module comprises at least two controllable blocks respectively comprising a variable gain optical amplifier VGA for selectively compensating power loss and a tunable dispersion compensation module TDCM for selectively compensating chromatic dispersion.

### FIELD OF THE INVENTION

The present invention relates to the field of designing, deploying and exploiting optical communication networks, more particularly to a technique for handling non-uniform individual characteristics of various transmission links or sections in optical communication networks.

### BACKGROUND OF THE INVENTION

The maximum distances optical signals can travel through an optical fiber before degrading to the point of being undetectable by a receiver is limited, among other things, by power loss due to attenuation introduced by the fiber and other components and by signal distortion due to chromatic dispersion, fiber nonlinearity and polarization mode dispersion (PMD).

The power loss due to the fiber and components' attenuation may be overcome by employing optical amplifiers that amplify the propagating signal, thus restoring its power. Transmission systems may include a series of optical amplifiers, usually erbium-doped fiber amplifiers (EDFAs), periodically spaced along the fiber route between the transmitter and the receiver. These amplifiers provide the necessary optical signal power.

The signal distortion due to chromatic dispersion in the fiber may be overcome by employing dispersion compensation modules (DCM) that compensate for the accumulated fiber dispersion, thus restoring the signal shape. Transmission systems may include a series of DCM, usually dispersion-compensated fibers (DCFs), periodically spaced along the fiber route between the transmitter and the receiver.

Although EDFAs and DCFs effectively reduce transmission impairment, they do not solve the problem of design complexity. In reality, the spacing between adjacent EDFAs and adjacent DCFs may significantly vary according to geographical constraints of the network. The varied spacing results in varied power loss in the fiber and varied dispersion that all need to be compensated. Thus, the required amplifier gain and the required amount of dispersion compensation are different at each network node/link. The great variation in the required amplification gain and dispersion compensation from node to node leads to a complex optical network design, the design where each node/link should be optically designed differently from each other.

US2005180757A describes a system, amplifier and method for amplifying an optical signal in an optical communications system where spans between amplifiers may vary. The system includes a Raman amplifier variable gain portion and an EDFA gain portion. The amount of Raman amplifier gain is chosen to trade off accumulation of noise with accumulation of multi-path interference. This variable Raman gain is used to equalize the loss of each span so that the amount of optical power supplied at the input of the EDFA gain portion is substantially constant throughout the system.

US2003016439AA discloses a system for gain equalization in an optical communication system, comprising a fiber link with a two-stage EDFA with an inter-stage access, and in the inter-stage a Dispersion Compensating Fiber, a Raman pump source (RMP) in the contra-propagating way, a Variable Optical Attenuator and a gain flattening filter. The Raman pump is adapted to provide a first gain slope with an opposite trend with respect to the filter and VOA, and is further adapted such that the pump power can be controlled so as to modify the gain slope and get the gain equalization.

### OBJECT AND SUMMARY OF THE INVENTION

Surprisingly, none of the prior art sources solves a long felt and complex problem known for optical networks, which is as follows: both when designing an optical network, and when maintaining proper functionality of the network, specialists must take care of each specific link/node of the network separately by considering length of each incoming optical link, power attenuation of the optical signal arriving via that link, chromatic dispersion of the signal and other individual parameters of that signal caused by conditions taking place in the specific link. None of the prior art sources discusses any uniform, single design approach to designing, deploying and operating an optical communication network/network section which comprises a plurality of optical links having essentially different lengths and characterized by various parameters of chromatic dispersion, polarization effects, etc.

According to a first aspect of the invention, the above object can be achieved by providing an adjustment module (preferably, a pre-manufactured one) to be inserted in an optical link of an optical communication network section, for compensating two or more different physical effects accumulating in said optical link when transmitting an optical signal there-along, the adjustment module comprising at least two controllable blocks respectively comprising:

a variable gain optical amplifier VGA for selectively compensating power loss, and

a tunable dispersion compensation module TDCM for selectively compensating chromatic dispersion.

In one embodiment, the adjustment module may comprise a pair of separate optical amplifiers, at least one of them being the mentioned variable gain amplifier.

In one example, these two amplifiers are a pair of EDFAs (erbium doped fiber amplifiers), where at least one of them (usually the 1^{st}) is a variable gain EDFA.

In another example, one of such separate amplifiers (usually the 1st) may be provided with a combination of functionalities: controllable Raman amplification+an EDFA.

Advantage of the embodiments comprising two separate amplifiers is in that the amplifiers are not likely to fail simultaneously.

In another embodiment, the mentioned variable gain optical amplifier may be in the form of a single double-stage optical amplifier usually implemented on one card. Preferably, such a double-stage optical amplifier is provided with mid-access (or mid-stage access); at least the tunable dispersion compensation module DCM can be inserted in the mid-stage.

The tunable dispersion compensation module may, for example, comprise a tunable dispersion element (such as an etalon, or a Fiber Bragg Grating). However, for broadening the possible range of the dispersion compensation, the tunable dispersion element can be combined with a fixed dispersion-compensation module (such as a dispersion compensation fiber DCF).

According to one preferred embodiment, said variable gain optical amplifier and said tunable DCM module are arranged in the adjustment module so as to be readily connected in a chain, wherein said chain comprises at least two contacts (preferably in the mid-stage of the double stage amplifier), and these two contacts may be either shortened with one another, or disconnected and used for switching at least one functional optical element into the chain.

The functional optical element can be, for example, Optical Add Drop Multiplexer (OADM), Reconfigurable OADM (ROADM), Multiplexer-Demultiplexer (MUX-DMUX), optical cross-connecting device, attenuator, or none of them such as a connecting optical fiber.

In one possible embodiment, the functional element(s) is (are) preliminarily built within the adjustment module and may even play part of a network node. For example, a specific network node (say, OADM) can be implemented by using at least one adjustment module incorporating OADM; by doing that, at least the respective one of the optical links incoming the OADM node will already be provided with suitable compensation of gain and dispersion. Other optical links incoming and outgoing the OADM node can be equipped with adjustment modules of a different type, possibly comprising different functional elements. Instead of the OADM node, one may imagine a similarly implemented cross-connecting node, ROADM node, etc.

The module is preferably provided with an internal controller, which may, for example, be an embedded controller capable of obtaining information for controlling the VGA and the TDCM and of performing said control.

Further, the adjustment module is provided with means for estimating/measuring the power loss and the chromatic dispersion, being in communication with the internal controller.

For providing that, the adjustment module is preferably equipped with means for OCM (optical channel monitoring) and DM (dispersion monitoring), these means may form part of an embedded controller. Based on data about power at optical channels and data on dispersion of the optical signal, the controller is capable of controlling gain of the variable gain amplifier and of tuning the DC module.

The OCM/DM means are preferred but not mandatory. The gain and dispersion in the adjustment module may be controlled by a controller based on information concerning length/power loss/dispersion of the incoming link.

Such information may be obtained from a preceding node or be otherwise available to the controller. The controller may be the embedded controller of the adjustment module, a controller of the node, or a control system of the network—such as a Network Management System NMS.

According to a further embodiment of the adjustment module, it also comprises a power equalizer block, preferably a Dynamic Gain Equalizer (DGE). The power equalization block usually requires an associated OCM means for its operation. Based on the information concerning optical channels, obtained from the OCM means, software of the controller controls operation of the DGE to equalize power per optical channel.

Optionally, the module may comprise a tunable polarization compensation block connectable in the chain with the variable gain amplifier VGA and the tunable dispersion compensation module TDCM.

Preferably, the range of said at least one variable gain optical amplifier should be selected to allow reasonable (from the point of those skilled in the art) compensation of power loss on the optical link expected to cause the maximal power loss in the network section of interest. Usually, when optical fibers of the same quality are used, the longest optical link in the specified network section is such a “worst” link.

The preferable range of the tunable dispersion compensation module should enable substantial compensation of chromatic dispersion in the optical link being most problematic from that point of view in the network section of interest (usually, the longest optical link in the network section if optical fibers are of the same type). The degree of compensation of power lost, dispersion, etc. must not be absolute but should be acceptable from the point of view of specialists in the field.

The described module having specific characteristics can be designed and especially manufactured for a particular network or network section. Alternatively, a number of types of the described modules can be manufactured is by serial production; a network designer may then select a particular type(s) of the adjustment module that suit(s) for a specific network section.

The adjustment modules may vary by presence or absence of the functional element, by type of the functional element, by ranges of regulation of the variable gain amplifier and of the dispersion compensation module, by possibilities of power equalization, etc. Though the price of such a ready-made uniform adjustment module seems to be quite high and the potential of the module can never be fully used at each and every optical link it is planned to serve, the use of the uniform adjustment modules significantly simplifies both the design and the deployment of optical networks which finally brings unification, modularity, possible standardization and economy.

According to a second aspect of the invention, there is provided a network node equipped or integrated with at least one above-described adjustment module for serving at least one respective optical link incoming the network node.

A third aspect of the invention is a network section comprising one or more network nodes and one or more optical links, wherein each node of the section is provided with at least one said adjustment module for at least one optical link incoming the node.

Actually, presence of the proposed adjustment modules at the links/nodes of the network section allows easily adjusting, compensating and/or equalizing effects of two or more different physical phenomena in a plurality of various optical links of the network section. Architecture of the network is unimportant. The described adjustment module is intended for per fiber use. For example, in an in-line node (say, a node of a ring network or a node of a point-to-point transmission path), two such adjustment modules will be needed for serving two links of two different transmission directions. In a mesh network where a node serves a number of incoming and outgoing links, more than two adjustment modules may be associated with the node.

In one practical embodiment of the network section, the adjustment modules utilized in the section are uniform, and ranges of their VGA and TDCM are such that they ensure substantial compensation of power loss and chromatic dispersion even in the “worst” optical links of the section.

According to a fourth aspect of the invention, there is also provided a method of arranging (i.e., designing, deploying, configuring, setting up) an optical network section comprising a number of network nodes and a number of optical links connecting said network nodes, the method comprising:

providing one or more of said adjustment modules at each node of the optical network section, for serving one or more respective optical links incoming a network node by suitably compensating power loss and chromatic dispersion expected to accumulate or accumulated in these respective one or more optical links.

Upon deploying the network section where the adjustment modules are connected in the respective optical links, the method further comprises a step of adjusting, at least at one specific one of said adjustment modules, and at least one parameter among a gain value of the variable gain amplifier VGA and a value of dispersion compensation of the tunable dispersion compensation module TDCM, to maximally compensate power loss and chromatic dispersion accumulated in the optical link served by said specific adjustment module. Preferably, the step of adjustment terminates when the power loss and the dispersion are substantially compensated in all optical links equipped with the adjustment modules.

The method may be performed when designing a network section, when establishing it, when performing maintenance operations in the network section and, of course, during operation of the network section.

Preferably, though not obligatory, the method comprises installing in the network section identical or uniform adjustment modules. In practice, these uniform modules are either especially designed for the specific network section, or selected among available types for that specific section, so as to allow reasonable compensation at least of the highest values of power loss and chromatic dispersion in the optical links of the network section.

The step of adjusting may additionally comprise adjusting power per channel, preferably by using a Dynamic Gain Equalization block DGE if present in one or more of the adjustment modules.

The step of adjusting, at each adjustment module, can be performed by a technician (for example, at the initial stage of the network deployment). However and preferably, especially during operation of the network section, the step of adjusting is performed automatically via a control unit.

In the best mode, the control unit used for that purpose is an internal local embedded controller of the adjustment module, which performs processing of data provided to it by blocks for monitoring optical channels (OCM) and dispersion (DM). These blocks may also be internal, i.e., pre-manufactured in the adjustment module, but may be provided externally to the adjustment module and placed at the network node. In that case, a single OCM monitoring block may serve a number of incoming optical links intermittently.

Based on the above, the method preferably comprises monitoring at least power of an optical signal incoming the adjustment module and chromatic dispersion of the signal, processing results of the monitoring and adjusting parameters of the adjustment module based on the processing.

In another version of the method, it comprises obtaining information about the distance to the previous node (i.e., information about length of the optical link) for estimating the power loss and/or the accumulated dispersion on the optical link without direct measurements. The operation of obtaining information can be ensured and supported by a Network Management System (NMS), and processing of results can be performed by a node controller or by the embedded controller of the adjustment module.

Actually, the Network Management System being in communication with various nodes of the network section can be used for adjusting parameters (i.e., at least one of those: gain of the VGA and value of dispersion compensation of the TDCM) of a number of adjustment modules of the network section. As has been noted, that can be done both with and without the use of OMS and DM monitoring blocks.

### BRIEF DESCRIPTION OF THE DRAWINGS

The invention will further be explained and illustrated with the aid of the following non-limiting drawings, in which:

FIG. 1 is a simplified block diagram of a basic embodiment of the module according to the invention.

FIG. 2 is a simplified block diagram of another embodiment of the adjustment module according to the invention.

FIG. 3 is a simplified block diagram of yet a further embodiment of the module according to the invention.

FIG. 4—an exemplary embodiment of a tunable DC module.

FIG. 5 is a simplified block diagram of an exemplary embodiment of the internally controllable adjustment module, comprising an embedded controller for controlling parameters of the adjustment module based on monitoring power and dispersion on the optical link served by the adjustment module.

FIG. 6—is a simplified sketch of an exemplary optical network section comprising one node, where optical links incomings the node are provided with the proposed adjustment modules.

### DETAILED DESCRIPTION OF PREFERRED EMBODIMENTS

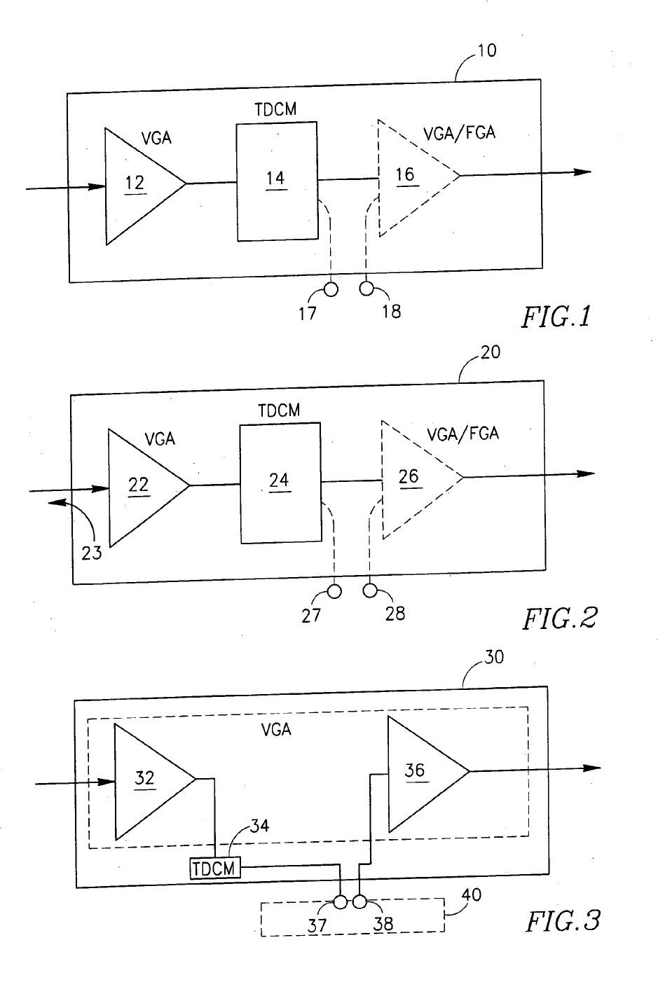

FIG. 1 shows a basic embodiment of the proposed ready-made adjustment module 10 for optical communication links, comprising a variable gain amplifier VGA 12 and a tunable dispersion compensation module TDCM 14 connected in a chain. Optionally and preferably, the adjustment module 10 comprises a second, additional amplifier 16 in the chain, which may be either a variable gain amplifier VDA or a fixed gain amplifier FGA. The figure further shows that, in case module 10 comprises the two amplifiers 12 and 16, the module may further be provided with two external contacts 17 and 18 to enable the insertion of a functional element into the chain between the amplifiers 12 and 16. These amplifiers may be two separate erbium doped fiber amplifiers—EDFAs. Alternatively, amplifiers 12 and 16 may constitute two stages of a double-stage optical amplifier, provided with contacts 17 and 18 in the mid-stage (see FIG. 3).

It should be noted that, within the adjustment module 10, the tunable block TDCM 14 may, in principle, be placed in the chain before the amplifier 12, or even after the amplifier 16.

A range of the variable gain optical amplifier VGA of the adjustment module should be selected to allow reasonable (from the point of those skilled in the art) compensation of power loss on the longest optical link/span in a specific optical communication network section for which the adjustment module is intended. For example, the adjustment module may comprise a variable gain optical amplifier EDFA with variable gain range of 20 dB (for example 15 dB to 35 dB gain).

Similarly, a range of the tunable dispersion compensation module TDCM should preferably be selected to enable substantial compensation of chromatic dispersion in the longest optical link/span of the network section of interest.

For example, the tunable dispersion compensation module (TDCM) can be made in the form of a tunable element (say, an etalon, a Bragg grating) providing dynamic dispersion compensation in the range of 800 ps/nm (for example 400 ps/nm to 1200 ps/nm). The average amount of dispersion compensation of the TDCM can be shifted by any required value by adding to the adjustment module a fixed DCF providing the required value of dispersion compensation.

FIG. 2 illustrates one possible embodiment 20 of the adjustment module that comprises a variable gain amplifier 22 provided with a Raman backward pump 23. The amplifier 22 may be a combination of an EDFA with the tunable Raman amplification.

FIG. 3 illustrates an embodiment 40, where amplifiers 32 and 36 constitute two stages of a double-stage optical amplifier 35 with variable gain (VGA), provided with a TDCM 34 in its mid-stage and further comprising external contacts 37 and 38 allowing insertion of any additional functional element(s) into the mid-stage of the double-stage amplifier 35. The figure shows an optional functional element 40 switched in the chain of the adjustment module 30 by utilizing the external contacts 37 and 38. The functional element may be, for example, an OADM, a ROADM, a MUX-DEMUX, optical cross-connecting device, an optical attenuator, etc. It should be noted, however, that the functional element 40 can be integrally incorporated in the adjustment module, and in this case can be shown inside the box 30.

Any type of the above-described adjustment modules (preferably, a set of modules with a specified range of variable parameters and probably with specified functional elements) may be especially manufactured for a particular network according to an order of the network designer/user.

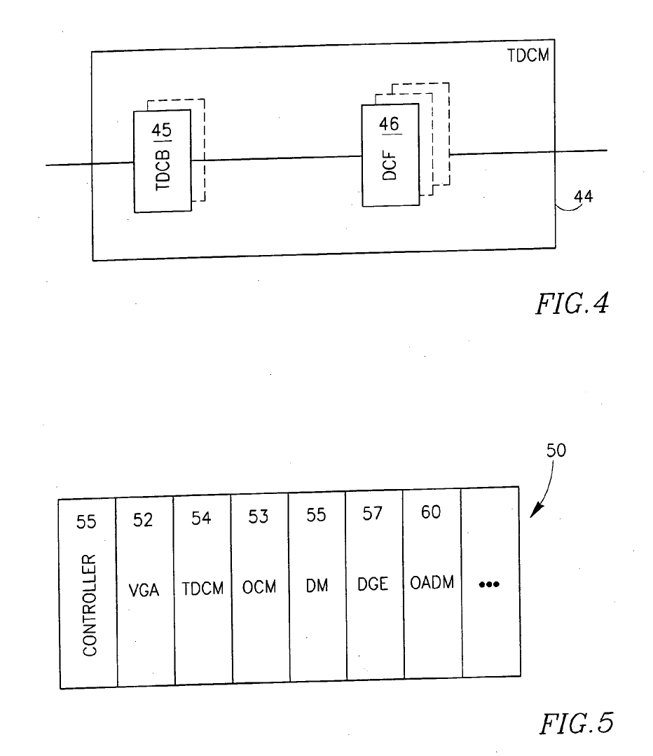

FIG. 4 illustrates a simplified block-diagram of an exemplary tunable dispersion compensation module TDCM 44, which comprises one or more tunable dispersion compensation blocks TDCB (say, etalons or Bragg gratings) 45 connected in chain to one or more fixed dispersion compensation fibers DCF 46. The order of connection of blocks 45 and 46 is unimportant.

For example, for obtaining the range of dispersion compensation between 0 and 40 km (i.e., providing compensation of dispersion which may be accumulated hi an optical link up to 40 km), one TDCB block tunable between 0 and 40 can be used, and it will be sufficient for serving optical links up to 40 km. However, when lengths of the optical links in the network vary in greater limits (say up to 80 km or more), the TDCM 44 should preferably comprise at least one DCF capable of compensating dispersion created on a 40 km optical link.

FIG. 5 schematically illustrates an exemplary embodiment of the pre-manufactured, internally controllable adjustment module 50. It presents an assembly comprising a card 52 of the variable gain optical amplifier VGA (for example, an EDFA card), a card 54 of the tunable dispersion compensation module TDCM, a card 55 of an embedded controller adapted to control parameters of the VGA 52 and the TDCM 54, for example based on monitoring power and dispersion in the optical link to which the module 50 is connected. It should be noted that alternatively, control of the adjustment module may be provided based on processing at least the following information: the distance to the previous node (i.e., the length of the optical link) and power at one or both ends of that link. Such control can be performed by the embedded controller 55, but in principle may be ensured by a controller of the node at which the adjustment module is situated, or by a network control unit.

Coining back to the exemplary embodiment shown in FIG. 5, here the power is monitored per channel using an Optical Channel Monitoring block (OCM) 53, and the dispersion is monitored by a dispersion monitoring unit (DM) 55. The OCM block may be part of the VGA card, and the DM unit may be part of the TDCM card.

The illustrated embodiment also comprises a dynamic gain equalizer DGE 57, which operates based on information about power per channel, obtained from the optical channel monitoring block OCM 53. The illustrated adjustment module 50 incorporates a functional element 60 being Optical Add Drop Multiplexer (OADM); the OADM 60 is served by the DGE 57 of the adjustment module. If the functional element 60 is a modern ROADM, the DGE block in the adjustment module may be absent since the DGE function is usually performed within the ROADM.

The pre-manufactured adjustment module 50 may be considered a ready-made network node.

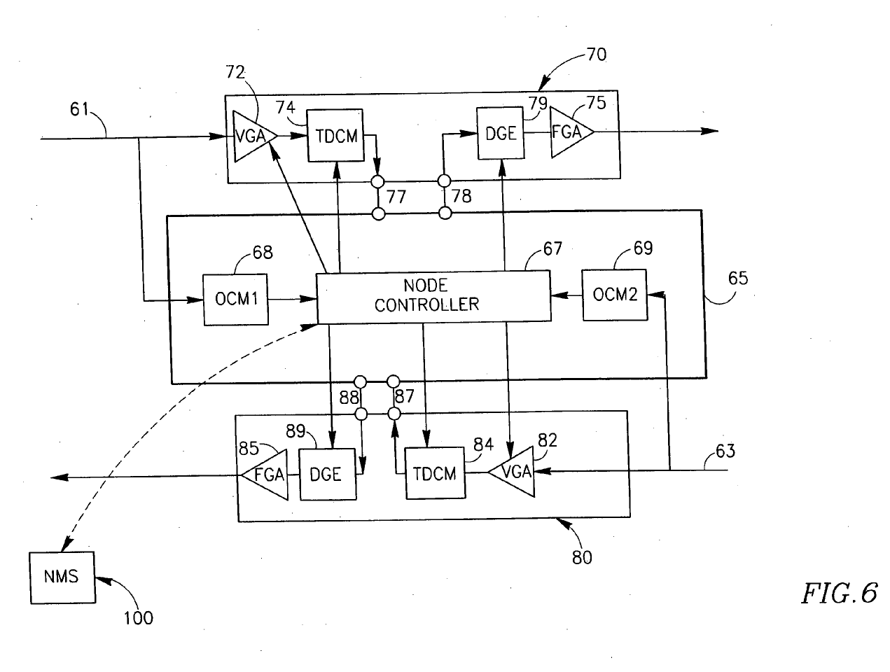

FIG. 6 schematically illustrates an exemplary optical network section, where a network node 65 (for example, an OADM) is provided with two proposed unified adjustment modules 70 and 80 for dynamic compensation of undesired effects which accumulate in two optical links 61 and 63 which ingress the node 65 and serve two directions of transmission via that node. Add/drop links of OADM are not shown in the figure, though they may also be provided with respective adjustment modules, if so required and desired.

Suppose that each of the adjustment modules 70 and 80 comprises a variable gain amplifier VGA 72 (82), a tunable dispersion compensation module TDCM 74 (84) a fixed gain amplifier FGA 75 (85) and a dynamic gain equalizer DGE 79(89).

The blocks TDCM, DGE and the very node 65 as a functional element are connected between each pair of the optical amplifiers: 72 and 75; 82 and 85. For connecting the node 65 to the adjustment module 70, contacts 77 and 78 are used. The adjustment module 80 is coupled to the node 65 via contacts 87 and 88. Node 65 provided with the modules 70 and 80 presents one exemplary implementation of the inventive network node.

In the drawing, the node 65 comprises a node controller 67 and is also equipped with a shared optical channel monitoring block OCM shown as two sub-blocks OCM1 68 and OCM2 69, to illustrate that the OCM block intermittently serves both of the opposite transmission directions. Based on the measurements performed by the shared OCM block, the node controller respectively controls gain of the VGA 72 and gain of the VGA 82. In this embodiment, the node controller 67 also controls the TDCM and the DGE blocks of the two adjustment modules 70 and 80.

The optical network, to which the node 65 belongs, comprises a Network Management System 100. According to the specific embodiment illustrated in that figure, the NMS 100 is in communication with the node controller 67. Inter alia, the network node controller 67 may obtain from the NMS the information about distances between the node 65 and neighboring nodes (not shown) in the network, which information can be processed in the controller 67 and used for tuning TDCM 74 and TDCM 84 of the adjustment modules 70 and 80.

The node 65 may be a cross-connecting device in a mesh network; in this case more than two incoming links may exist, and each may be provided with an adjustment module.

It should be appreciated that the proposed adjustment module, network node, network section and method for arranging a network section may be implemented in a number of differing embodiments and versions which, though not described in detail in the present description, should be considered part of the invention whenever defined by the claims which follow.

1-22. (canceled)

23. An adjustment module to be inserted in an optical link of an optical network section for compensating two or more different physical effects accumulated in said optical link when transmitting an optical signal there-along, the adjustment module comprising at least two controllable blocks respectively comprising:
a variable gain optical amplifier VGA for selectively compensating power loss, and
a tunable dispersion compensation module TDCM for selectively compensating chromatic dispersion;
the adjustment module being provided with an internal control unit capable of obtaining information and for controlling the VGA and the TDCM based on said information.

24. The adjustment module according to claim 23, wherein said variable gain optical amplifier is a double-stage optical amplifier provided with access to its mid-stage, and wherein the tunable dispersion compensation module TDCM is inserted in the mid-stage.

25. The adjustment module according to claim 23, wherein said VGA and said TDCM are arranged in the adjustment module so as to be readily connected in a chain, wherein said chain comprises at least one gap formed between two external contacts for switching at least one functional optical element into the chain.

26. The adjustment module according to claim 23, further comprising at least one functional optical element incorporated within said adjustment module, wherein said at least one functional optical element is selected from a list comprising: a network node, OADM, ROADM, MUX-DMUX, optical cross-connecting device, optical attenuator, a connecting optical fiber.

27. The adjustment module according to claim 23, controllable from an external control unit.

28. The adjustment module according to claim 23, further provided with means for measuring power loss and chromatic dispersion on said optical link and being in communication with the internal control unit.

29. A network node being equipped with at least one adjustment module according to claim 23, for serving at least one respective optical link incoming the network node.

30. A network section comprising a number of network nodes and a number of optical links, wherein each network node of said network section is the network node according to claim 29.

31. The network section according to claim 30, wherein the adjustment modules utilized in the network section are identical, and wherein ranges of the VGA and TDCM of the adjustment modules are such as to ensure substantial compensation of the maximal possible power loss and/ or of the maximal possible chromatic dispersion expected to be accumulated in an optical link of the network section.

32. A method of arranging an optical network section comprising a number of network nodes and a number of optical links connecting said network nodes, the method comprising:
providing at least one adjustment module, according to claim 23, at each specific network node of the optical network section for serving at least one respective optical link incoming said specific network node by suitably compensating power loss and chromatic dispersion expected to accumulate or accumulated in said at least one respective optical link.

33. The method according to claim 32, further comprising adjusting parameters of the network section by suitably compensating power loss and chromatic dispersion, wherein the step of adjusting is performed under external control.
